(19) United States
(12) Patent Application Publication
(10) Pub. No.: US 2003/0214618 A1
(43) Pub. Date: Nov. 20, 2003

(54) Liquid crystal display device with bump and method for manufacturing the same

(75) Inventors: Su Tao, Kaohsiung (TW); Kuo-Chung Yee, Taipei (TW); Jen-Chieh Kao, Kaohsiung (TW); Chih-Lung Chen, Fengshan City (TW); Hsing-Jung Liau, Kaohsiung (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: ADVANCED SEMICONDUCTOR ENGINEERING, INC.

(21) Appl. No.: 10/412,349

(22) Filed: Apr. 14, 2003

(30) Foreign Application Priority Data
May 17, 2002 (TW) 91110825

(51) Int. Cl. G02F 1/1345

(52) U.S. Cl. 349/151

(57) ABSTRACT

A Liquid crystal display device comprises a base chip, a transparent substrate, a bump ring, and liquid crystal material. The base chip has a plurality of pixel electrodes, a bonding pad ring surrounding the pixel electrodes and a plurality of bonding pads positioned outside the bonding pad ring, electrically connected to the pixel electrodes and adapted being electrically connected to an external circuit. The transparent substrate has a bonding pad ring corresponding to the bonding pad ring of the base chip. The bump ring is disposed between the bonding pad ring of the base chip and the bonding pad ring of the transparent substrate for bonding the base chip and the transparent substrate so as to form a hermetical cavity. The liquid material is filled within the hermetical cavity.

### BACKGROUND OF THE INVENTION

1. Field of the Invention

The present invention is related to a liquid crystal display device and a method for manufacturing the same, and more particularly, related to a reflective panel display and a method for manufacturing the same at wafer level.

2. Description of the Prior Art

Due to the advance of electronic technology, especially for the popularity of portable electronic products, the requirements of light, compact and low-energy consuming display are gradually increasing. With the advantages of low-energy consuming, low-heat dissipation, light weight and non-luminescence, liquid crystal displays (LCD) have been widely used in the electronic products and even have replaced the traditional CRT displays.

An LCD basically consists of polarizers, glass electrodes and liquid crystal materials. The polarizers are made of the polarizing material sandwiched between two transparent films. The glass electrodes are made of high quality flat glass which is plated with a layer of conductive film of metallic oxidation. The molecules of liquid crystal material possess very strong electron conjugation moving ability. When the liquid crystal molecules are applied with electric field, they are easily polarized to produce induced dipolar phenomena, thereby resulting in the displaying image in the LCD.

A microdisplay can be defined as a flat-panel display technology in which the display has a diagonal of typically less than 3 inches. Microdisplays have advantages over other display types in many applications because they are relatively inexpensive to manufacture, are physically small (leading to compact and less expensive optical systems), they can produce an image with very high resolution, aperture ratio, contrast ratio and brightness, and they consume a relatively low amount of power.

A technology within the category of reflective microdisplays is Liquid-Crystal-On-Silicon (LCOS). LCOS systems are a variation on liquid crystal displays in which the back substrate is replaced by a silicon die upon which resides an actively addressed reflective pixel array. It is desired herein to provide an LCOS reflective microdisplay. In addition, the LCOS is fabricated using materials and processes that are compatible with those currently used in existing commercial wafer and display foundries.

US Patent Publication Application US2002/0001056 A1, entitled “Reflective Microdisplay For Light Engine Based Video Projection Applications”, incorporated herein by reference, discloses a reflective microdisplay used in the light engine based video projection. However, this application did not provide a suitable method for manufacturing the microdisplay.

Besides, U.S. Pat. No. 6,222,603 B1, entitled “Method of Manufacturing Liquid Crystal Display Device With a Double Seal” issued on Apr. 24, 2001 to Salai et al, discloses a method for manufacturing a liquid crystal display device, wherein the liquid crystal material is filled by dropping. This patent is incorporated herein by reference.

Furthermore, in the conventional wafer-level semiconductor package, the method of wafer-to-wafer bonding is substantially divided into three types: silicon fusion, anodic bonding and intermediate-layered bonding. However, there are many drawbacks in these conventional processes, such as high manufacturing temperature, thermal mismatch, unsealed, and outgasing problem.

Accordingly, there exists a need for a method for manufacturing a microdisplay of an LCOS to solve the above mentioned problems and disadvantages.

### SUMMARY OF THE INVENTION

It is an object of the present invention to provide a method for a liquid crystal display with bumps capable of bonding the wafer at the low temperature so as to ensure the reliability of semiconductor element.

To achieve the object mentioned above, the present invention provides a liquid crystal display device comprising a base chip, a transparent substrate, a bump ring, and liquid crystal material. The base chip has a plurality of pixel electrodes, a bonding pad ring surrounding the pixel electrodes and a plurality of bonding pads positioned outside the bonding pad ring, electrically connected to the pixel electrodes and adapted being electrically connected to an external circuit. The transparent substrate has a bonding pad ring corresponding to the bonding pad ring of the base chip. The bump ring is disposed between the bonding pad ring of the base chip and the bonding pad ring of the transparent substrate for bonding the base chip and the transparent substrate so as to form a hermetical cavity. The liquid material is filled within the hermetical cavity.

The present invention further provides a method for manufacturing a liquid crystal display device, comprising the steps of: (a) providing a base wafer having a plurality of base chips separated by scribe lines wherein each of the base chips is provided with a bonding pad ring, a plurality of bonding pads positioned outside the bonding pad ring, and pixel electrodes; (b) forming a bump ring on the bonding pad ring of each of the base chips; (c) dispensing liquid crystal material into the bump ring on the base chip; (d) providing a transparent sheet having a plurality of the transparent substrates separated by scribe lines corresponding to the scribe lines of the base wafer, and a plurality of bonding pad rings corresponding to the plurality of bonding pad rings of the base wafer; (e) aligning and bonding the base wafer and the transparent sheet so that the plurality of bump rings of the base wafer is correspondingly joined to the plurality of bonding pad rings of the transparent sheet, respectively, and a plurality of hermetical cavities between the base wafer and the transparent sheet is formed; and (f) cutting the base wafer and the transparent sheet along the scribe lines of the base wafer and the transparent sheet, respectively, to individuate the liquid crystal display device.

The process for manufacturing the package according to the present invention uses the gold bumps so as to bond the base wafer and the transparent substrate in vacuum at temperature below 150° C. The process is belonged to a cold welding process, and adapted to manufacturing the package with various semiconductor elements. It will be apparent to those skilled in the art that the gold bump can be easy replaced with the solder bump. Hardness metal, such as gold or solder in place of conventional outgasing material, such as epoxy resin, is used to form a hermetical cavity between two wafer and thus ensure the reliability of the liquid crystal display cell.

### BRIEF DESCRIPTION OF THE DRAWINGS

The above and other objects, aspects and advantages of the present invention will become apparent from the following description of embodiments with reference to the accompanying drawings in which:

FIG. 1 is a cross sectional view of a liquid crystal display device with gold bumps according to an embodiment of the present invention embodiments with gold bump.

FIGS. 2 to 9 show the manufacturing method of the liquid crystal display device with bumps according to an embodiment of the present invention.

### DESCRIPTION OF THE PREFERRED EMBODIMENTS

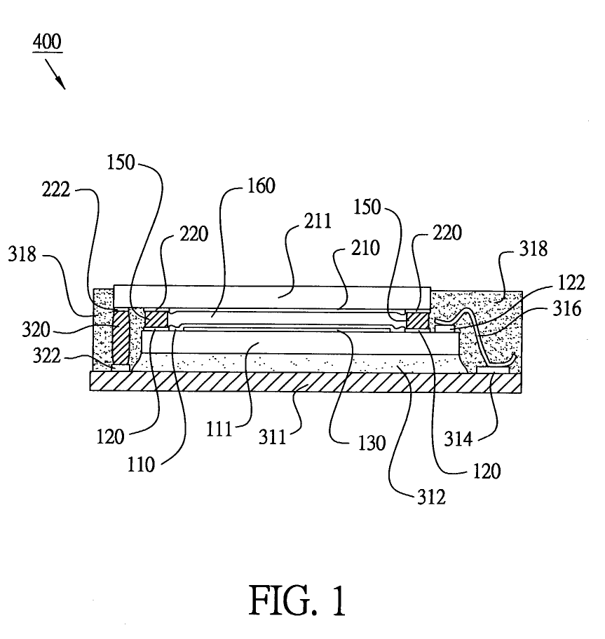

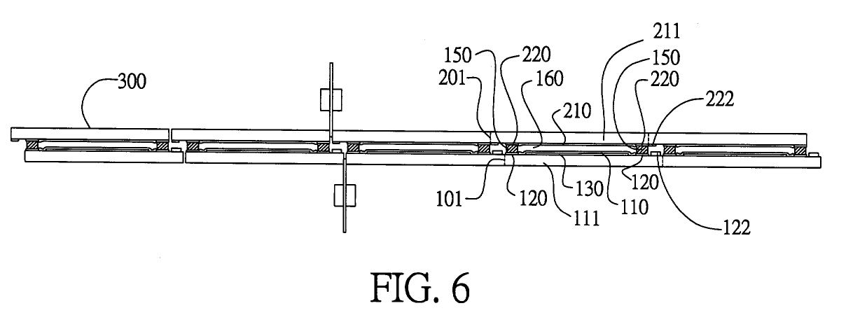

As shown in FIG. 1, it depicts the liquid crystal display device 400 according to a embodiment of the present invention. The liquid crystal display device 400 mainly comprises a substrate 311, a base chip 111 and a transparent substrate 211 spaced apart from the base chip 111 with a gold bump ring 150. The gold bump ring 150, the base chip 111 and the transparent substrate 211 is cooperated to form a hermetical cavity, into which liquid crystal material 160 is filled so as to form a liquid crystal display cell 300, as shown in FIG. 6. The liquid crystal display cell 300 is adhered to the substrate 311 by the adhesive 312, and the base chip 111 is provided with bonding pads 122 for electrically connecting to bonding pads 314 of the substrate 311 through bonding wires 316. The transparent substrate 211 is also provided with the bonding pads 222 for electrically connecting to bonding pads 322 of the substrate 311.

The base chip 111 comprises the circuit and pixel electrodes 130 of the liquid crystal display electrically connected to a plurality of the bonding pads 122. Also, the bonding pads 122 is electrically connected to the bonding pad 314 of the substrate 311 so that the liquid crystal display cell 300 can be connected to an external circuit, such as the control and driver circuit of the liquid crystal display, so as to control the pixel electrode 130 and the liquid crystal display device 400 for showing the image. The liquid crystal display device 400 can be any type of the liquid crystal display device, such as active matrix display and passive matrix display, and the liquid crystal material 160 can be any type of liquid crystal, such as twisted nematic liquid crystal (TN-LC), supertwisted nematic liquid crystal (STN-LC), ferroelectric liquid crystal (FLC) and the like. Furthermore, the insides of the base chip 111 and the transparent substrate 211 comprise polarizing films 110 and 210 to align the liquid crystal molecule, respectively.

The transparent substrate 211 is provided with a bonding pad ring 220 corresponding to the bonding pad ring 120 on the base chip 11, and the bonding pad ring 120, 220 is exposed out of the polarizing films 110, 210. The gold bump ring 150 is formed between the bonding pad ring 120, 220 for joining the basis chip 111 and the outer cover chip 211 so as to form a hermetical cavity, and surrounds the display area of the liquid crystal display cell 300. Further, under bump metallurgy (UBM) (not shown) is disposed between the bonding pad rings 120, 220 and gold bump 150 and is provided with a adhesion layer, a barrier layer, and a wetting layer for enhancing the electrical and mechanical connection between the gold bump ring 150 and the bonding pad rings 120, 220.

The transparent substrate 211 can be made of a high-resistance transparent material, such as transparent polymer, glass, quartz, sapphire. It will be apparent to those skilled in the art that the transparent substrate 211 further comprises transparent electrodes (not shown) typically made of indium tin oxide (ITO) and disposed between the transparent substrate 211 and the polarizing film 210. The transparent electrodes are electrically connected to the bonding pads 222 which are electrically connected to the bonding pads 322 of the substrate 311 through conductive adhesive 320.

The liquid crystal display device 400 further comprises an encapsulant 318 to encapsulate the liquid crystal display cell 300 and the substrate 311, and the transparent substrate 311 is exposed out of the encapsulant 318. In this arrangement, light can be transmitted into the liquid crystal display cell 300 through the transparent substrate 311 and be reflected by the pixel electrodes such that the liquid crystal display device 400 generates images.

Now referring to FIGS. 2 to 9, they depict a method for manufacturing the liquid crystal display device 400 with gold bump according to the present invention. Hereinafter, like reference numerals indicate like elements through the figures.

As show in FIG. 2, a base wafer 100 comprises a plurality of base chip 111 separated form each other by scribe lines 101. A bonding pad ring 120 is disposed on the base chip 111 and surrounds the pixel electrode 130 to define the display area of the liquid crystal display cell, and a plurality of bonding pads 122 are disposed outside the bonding pad ring 120. Each of the chips 111 comprises a bonding pad ring 120 and a plurality of bonding pads 122, and the amount of the bonding pad 122 depends on the design of the pixels and the output/input circuit of the chip 111. The polarizing film 110 (not shown in FIG. 2) is formed on the upper surface of the pixel electrodes 130, and the bonding pad ring 120 and bonding pad 122 are exposed out of the polarizing film 110.

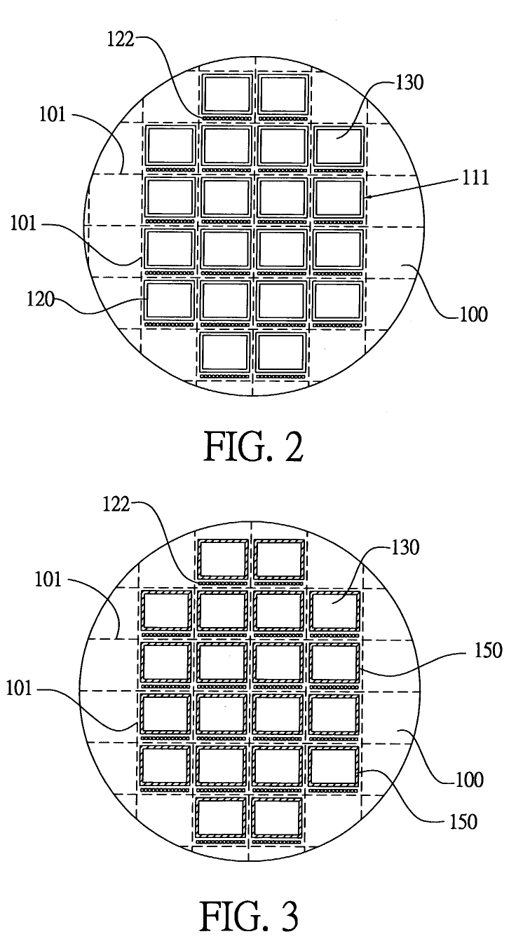

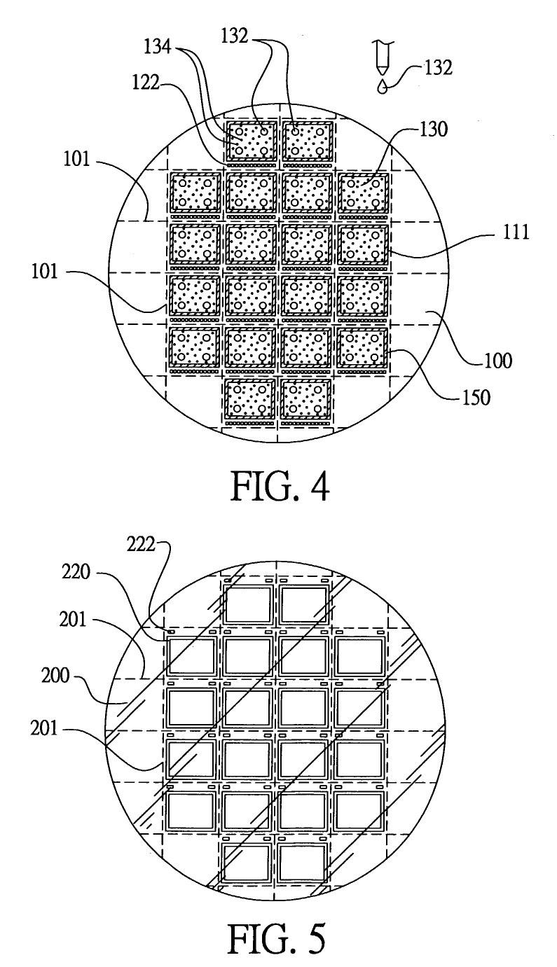

As shown in FIG. 3, a gold bump ring 150 is formed on the bonding pad ring 120, and provides a predetermined thickness, i.e. the cell gap of the liquid crystal display cell 300. The gold bump ring 150 generally comprises at least about 90 wt % of gold. Again referring to FIG. 4, spacers 134 of the liquid crystal display cell 300 are spread over the display area by means of the known process, such as spraying or lithographing, so as to keep the cell gap. Then, a liquid crystal material 132 which has been measured is dispensed to the display area.

As shown in FIG. 5, a transparent sheet 200 comprises a plurality of transparent substrate 211, the adjacent transparent substrates 211 are spaced apart by the scribe line 201. A bonding pad ring 220 is disposed on the transparent substrate 211 corresponding to the bonding pad ring 120 of the base chip 111 and gold bump ring 150. A plurality of bonding pads 222 are disposed outside the bonding pad ring 120. The bonding pad 222 can be connected to the common/transparent electrodes of the transparent substrate 211. The polarizing film 210 (not shown in FIG. 5) is formed on the lower surface of the transparent sheet 200 and the bonding pad ring 220 and bonding pad 222 is exposed. Then, the transparent sheet 200 is aligned with the base chip 100 so that the bonding pad ring 120 of the base chip 111 is aligned with the bonding pad ring 220 of the transparent substrate 211, and then a bonding wafer is formed by the thermocompression bonding process or thermosonic bonding process.

In the thermosonic bonding process, first one of the base wafer 100 and the transparent sheet 200 is positioned on a hot stage, and the temperature is kept from about 100° C. to about 150° C. during the process. The other then is aligned, and is heated and compressed so that the base wafer 100 and the transparent sheet 200 are in contact with one another. When the pressure is increased to a predetermined level, the ultrasonic at a frequency of 20 to 60 kHZ and at an amplitude of 20 to 200 mm is inputted to induce the cold welding effect by the sonic vibration and bond the base wafer 100 and the transparent sheet 200. The input ultrasonic is useful for removing the oxide layer and pollution on the surface of the bonding pads and further combines with the heat to facilitate the bonding the base wafer 100 and the transparent sheet 200.

Then, as shown in FIG. 6, the bonding wafer is cut by a cutting tool along the scribe lines 101 and 210 so as to individuate the liquid crystal display cell 300. During the cutting process, the bonding wafer can be cut away a portion of thickness alone the scribe line 101, 201 by the cutting tool, and then is split by the mechanics to individuate the liquid crystal display cell 300, thereby preventing the cutting tool from mis-cutting and the liquid crystal display cell 300 of the bonding wafer from damaging.

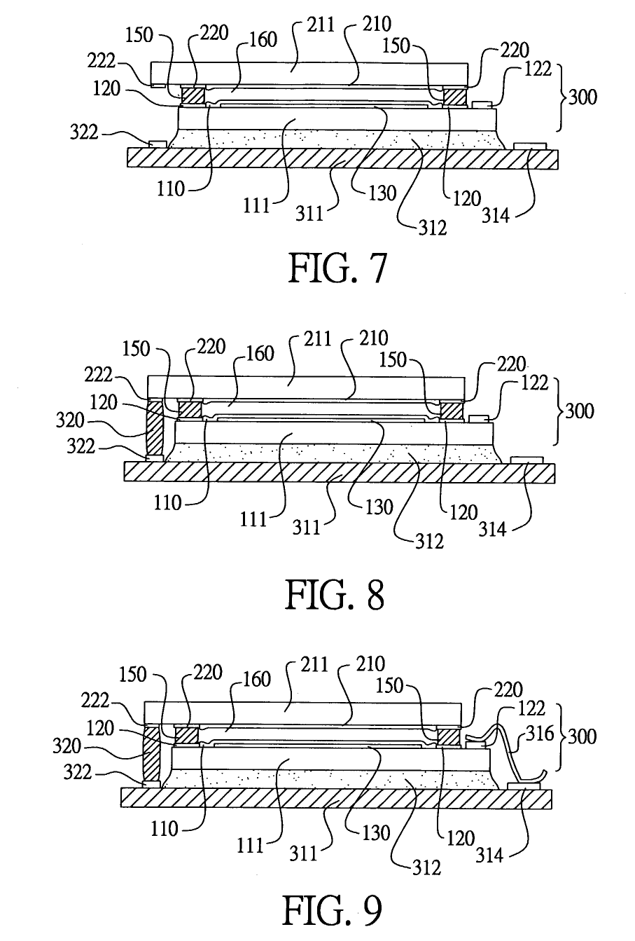

As shown in FIG. 7, the liquid crystal display cell 300 is adhered to a substrate 311 by an adhesive layer 312. The substrate 311 is electrically connected to external circuits and is provided with bonding pads 314 and 322. As shown in FIG. 8, the bonding pad 322 of the substrate is electrically connected to the bonding pad 222 by the conductive adhesive 320. As shown in FIG. 9, the bonding pad 122 of the base chip 111 is electrically connected to the bonding pad 314 of the substrate by the bonding wire. Finally, an encapsulant is provide to encapsulate liquid crystal display cell 300, the substrate 311, and the bonding wires 316 so as to form the liquid crystal display device 400 shown in FIG. 1.

The process for manufacturing the package according to the present invention uses the gold bumps, and bonds the base wafer and the transparent substrate in vacuum at temperature below 150° C. The process is belonged to a cold welding process, and adapted to manufacturing the package with various semiconductor elements. It will be apparent to those skilled in the art that the gold bump can be easy replaced with the solder bump. Hardness metal, such as gold or solder in place of conventional outgasing material, such as epoxy resin, is used to form a hermetical cavity between two wafer and thus ensure the reliability of the liquid crystal display cell.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A liquid crystal display device comprising:
a base chip having a plurality of pixel electrodes, a bonding pad ring surrounding the pixel electrodes, and a plurality of bonding pads positioned outside the bonding pad ring, electrically connected to the pixel electrodes and adapted for being electrically connected to an external circuit;
a transparent substrate having a bonding pad ring corresponding to the bonding pad ring of the base chip; and
a bump ring positioned between the bonding pad ring of the base chip and the bonding pad ring of the transparent substrate; and
liquid crystal material filled inside the bump ring between the base chip and transparent substrate.

2. A liquid crystal display device according to claim 1, further comprising a substrate adhered to the outside surface of the base chip and having a plurality of bonding pads electrically connected to the plurality of bonding pads of the base chip.

3. A liquid crystal display device according to claim 1, wherein the transparent substrate further comprises a transparent electrode and a plurality of bonding pads positioned outside the bonding pad ring and electrically connected to the transparent electrode.

4. A liquid crystal display device according to claim 3, further comprising a substrate adhered to the outside surface of the base chip, and having a plurality of first bonding pads electrically connected to the plurality of bonding pads of the base chip and a plurality of second bonding pads electrically connected to the plurality of bonding pads of the transparent substrate.

5. A liquid crystal display device according to claim 1, wherein the transparent substrate is made of the material selected from the group consisting of transparent polymer, glass, quartz, and sapphire.

6. A liquid crystal display device according to claim 1, wherein the bump ring is a gold bump ring.

7. A liquid crystal display device according to claim 1, wherein the bump ring is a solder bump ring.

8. A method for manufacturing a liquid crystal display device, comprising the steps of:
providing a base wafer having a plurality of base chips separated by scribe lines wherein each of the base chips is provided with a bonding pad ring, a plurality of bonding pads positioned outside the bonding pad ring, and pixel electrodes;
forming a bump ring on the bonding pad ring of each of the base chips;
dispensing liquid crystal material into the bump ring on the base chip;
providing a transparent sheet having a plurality of the transparent substrates separated by scribe lines corresponding to the scribe lines of the base wafer, and a plurality of bonding pad rings corresponding to the plurality of bonding pad rings of the base wafer;
aligning and bonding the base wafer and the transparent sheet so that the plurality of bump rings of the base wafer is correspondingly joined to the plurality of bonding pad rings of the transparent sheet, respectively, and a plurality of hermetical cavities between the base wafer and the transparent sheet is formed; and
cutting the base wafer and the transparent sheet along the scribe lines of the base wafer and the transparent sheet, respectively, to individuate the liquid crystal display device.

9. The method according to claim 8, further comprising the steps of:
providing a substrate having a plurality of bonding pads;
adhering the substrate to the outside of the base chip of the liquid crystal display device; and
electrically connecting the bonding pads of the substrate to the bonding pads of the base chip.

10. The method according to claim 8, further comprising the steps of:
forming a transparent electrode deposited on the transparent sheet, and a plurality of bonding pads deposited outside the bonding pad rings on the transparent sheet and electrically connected to the transparent electrode;
providing a substrate having a plurality of first bonding pads and a plurality of second bonding pads;
adhering the substrate to the outside of the base chip of the liquid crystal display device;
electrically connecting the first bonding pads of the substrate to the bonding pads of the transparent sheet; and
electrically connecting the second bonding pads of the substrate to the bonding pads of the base chip.

11. The method according to claim 8, wherein the transparent substrate is made of the material selected from the group consisting of transparent polymer, glass, quartz, and sapphire.

12. The method according to claim 8, wherein the bump ring is a gold bump ring.

13. The method according to claim 8, wherein the bump ring is a solder bump ring.
